(19) United States
(12) Patent Application Publication
(10) Pub. No.: US 2013/0193079 A1
(43) Pub. Date: Aug. 1, 2013

(54) Water Purification System

(71) Applicant: Electrolytic Ozone Inc., Wilmington, MA (US)

(72) Inventors: Jeffrey D. Booth, Andover, MA (US); Hossein Zarrin, Winchester, MA (US); Carl David Lutz, Windham, NH (US)

(73) Assignee: ELECTROLYTIC OZONE INC., Wilmington, MA (US)

(21) Appl. No.: 13/744,298

(22) Filed: Jan. 17, 2013

Related U.S. Application Data
(60) Provisional application No. 61/587,635, filed on Jan. 17, 2012.

(51) Int. Cl. C02F 1/78

(52) U.S. Cl. CPC C02F 1/78
USPC 210/739; 210/96.1

(57) ABSTRACT

A water purification system disinfects incoming water by filtering the water before creating ozone from the water and directly into the water. After the water is disinfected by exposure to ozone, excess ozone is removed prior to providing the disinfected water to an end user. Some embodiments divide the incoming water into a divided water flow, and provide only one of the flows to the ozonating electrode. Some embodiments include a feedback network for controlling the system to produce purified water, and/or to maintain the purity of previously-purified water.

### PRIORITY

The present application claims priority from U.S. provisional application Ser. No. 61/587,635, filed Jan. 17, 2012, titled “Water Purification System” and naming Jeffrey D. Booth, Hossein Zarrin, and Carl David Lutz as inventors. The foregoing application is hereby incorporated herein by reference in its entirety.

### TECHNICAL FIELD

The present invention relates to water purification systems, and more particularly to ozone-based water purification systems.

### BACKGROUND ART

It is known in the prior art to purify water using a variety of methods, including exposing the water to ultraviolet radiation, or injection of ozone-containing gas into the water.

A leading technology for providing water purification is to use UV bulbs to irradiate potentially contaminated water for the purpose of clearing it of bacteria. These systems are energy consumers due to the need for high wattage UV bulbs. Further, they require direct contact of the UV rays with the bacteria. It is almost impossible to provide a UV irradiated water flow system that does not have some interstices that will block direct contact with all of the water present. This can leave small colonies of bacteria which can continue to grow.

Systems for purifying water with ozone tend to be large, expensive and complicated. For example, creating ozone-containing gas by coronal discharge produces far more waste gas than ozone, and also carries into the water any impurities present in the source gas. Such impurities and waste gas must be addressed, often at considerable cost.

### SUMMARY OF THE EMBODIMENTS

A first embodiment of a system for purifying water with ozone includes a water inlet for receiving unpurified water; a pre-filter in fluid communication with the water inlet; a variable-output ozonation cell having a control input and a doped diamond electrode, and configured to create ozone from the water, the ozonation cell in fluid communication with the pre-filter; a water reservoir configured to store ozonated water, the water reservoir in fluid communication with the ozonation cell; an ozone removal chamber configured to receive ozonated water from the water reservoir, and configured remove ozone from the water; a system outlet in fluid communication with the ozone removal chamber, and configured to output purified water, the water inlet, pre-filter, ozonation cell, water reservoir, ozone removal chamber, and system outlet defining a fluid path through the system; and a feedback circuit. The feedback circuit includes an ozonation sensor coupled to the fluid path downstream from the ozonation cell, the ozonation sensor coupled to detect the level of ozone in the ozonated water; and a controller configured to receive ozone data from the ozone sensor, and configured to control the ozone production of the ozonation cell.

The water reservoir further may include a reservoir ozonation cell in fluid contact with the ozonated water and in electrical communication with the controller, as well as a reservoir ozonation sensor configured to detect ozone levels in ozonated water within the reservoir, the reservoir ozonation sensor in electrical communication with the controller. The controller is configured to cause the reservoir ozonation cell to produce ozone from water within the reservoir when the reservoir ozonation sensor detects ozone levels within the ozonated water less than a pre-determined threshold.

Alternately, the system may include a recirculation conduit configured to pass water from the water reservoir back to the ozonation cell, and the controller is configured to recirculate water from the water reservoir to the ozonation cell via the recirculation conduit, and to cause the ozonation cell to re-ozonate the recirculated water, when the reservoir ozonation sensor detects ozone levels within the ozonated water less than a pre-determined threshold.

In some embodiments, the system may include a water flow sensor coupled to the fluid path and configured to determine whether and/or how much water is flowing along at least a portion of the fluid path; and a reservoir ozonation cell in fluid contact with the ozonated water within the reservoir. In such embodiments, the controller is configured to assess data from the water flow sensor and to cause the reservoir ozonation cell to produce ozone from water within the reservoir if no water has flowed past the water flow sensor during a pre-determined interval. Alternately, or in addition, the system may include a recirculation conduit configured to pass water from the water reservoir back to the ozonation cell, and the controller may be configured to assess data from the water flow sensor and to recirculate water from the water reservoir to the ozonation cell via the recirculation conduit, and to cause the ozonation cell to re-ozonate said water, if no water has flowed past the water flow sensor during a pre-determined interval.

In various embodiments, the filter may be one or more of a carbon filter, and a stacked-type physical filter. In addition, the system may include a reverse osmosis filter in the fluid path between the pre-filter and the ozonation cell. Further, in some embodiments, the variable-output ozonation cell further includes a membrane (such as a PEM membrane, for example) fluidly isolating the anode from the cathode, and the reverse osmosis filter has a first output, and a second output fluidly isolated from the first output. The first output of the reverse osmosis filter provides R.O. filtered water to an anode side of the variable-output ozonation cell, and the second output of the reverse osmosis filter provides waste water to the cathode side of the variable-output ozonation cell, such that the waste water remains separate from ozonated water within the variable-output ozonation cell.

In various embodiments, the ozone removal chamber may include a source of UV light, and/or a carbon post filter. In other embodiments, the ozone removal chamber be include a pressure-reducing nozzle configured to reduce the pressure in flowing water so as to cause ozone to outgas from the water, while in yet other embodiments the ozone removal chamber may include a pump configure to remove ozone from the water. In addition, the ozone removal chamber includes a non-toxic ozone quenching chemical infusion element configured to provide a non-toxic ozone quenching chemical (such as sodium thiosulfate for example) into the water.

A method of operating a water purification system, includes passing water through at least one pre-filter; passing the water through an ozonator downstream from the pre-filter; capturing the water in a reservoir downstream from the ozonator; determining whether to re-ozonate the water in the reservoir; and -f the ozone level in the water is below a pre-determined threshold for example, re-ozonating the water in the reservoir.

The step of monitoring the ozone level of the water in the reservoir may include sensing the ozone level via an ozone sensor.

The step of monitoring the ozone level of the water in the reservoir may include monitoring water flow through the water purification system and determining whether the water flow is below a pre-determined threshold. The step of determining whether the water flow is below a pre-determined threshold may include determining whether the water flow has been below the pre-determined threshold for a predetermined period of time.

In some embodiments, the step of re-ozonating the water in the reservoir includes recirculating at least a portion of the water in the reservoir through the ozonator. Alternately, or in addition, the step of re-ozonating the water in the reservoir may include providing ozone to the water in the reservoir via a reservoir ozonator within the reservoir.

A system for purifying water with ozone, includes a water inlet means for receiving unpurified water; a pre-filter mean in fluid communication with the water inlet means; a variable-output ozonation means including a control input and a doped diamond electrode, and configured to create ozone from the water, the ozonation means in fluid communication with the pre-filter; a water reservoir means configured to store ozonated water, the water reservoir in fluid communication with the ozonation cell; an ozone removal means configured to receive ozonated water from the water reservoir, and configured remove ozone from the water; a system outlet means in fluid communication with the ozone removal chamber, and configured to output purified water, the water inlet means, pre-filter, ozonation means, water reservoir means, ozone removal means, and system outlet means defining a fluid path through the system; and a feedback means. The feedback means may include an ozonation sensor coupled to the fluid path downstream from the ozonation means, the ozonation sensor coupled to detect the level of ozone in the ozonated water; and a controller means configured to receive ozone data from the ozone sensor, and configured to control the ozone production of the ozonation cell.

### BRIEF DESCRIPTION OF THE DRAWINGS

The foregoing features of embodiments will be more readily understood by reference to the following detailed description, taken with reference to the accompanying drawings, in which:

FIG. 1A schematically illustrates an embodiment of a system for purifying water with ozone;

FIG. 1B schematically illustrates another embodiment of a system for purifying water with ozone;

FIG. 1C schematically illustrates another embodiment of a system for purifying water with ozone;

FIGS. 1D and 1E schematically illustrate methods for operating a feedback system;

FIG. 2A schematically illustrates another embodiment of a system for purifying water with ozone;

FIG. 2B schematically illustrates another embodiment of a system for purifying water with ozone;

FIG. 3 schematically illustrates another embodiment of a system for purifying water with ozone;

FIG. 4 schematically illustrates another embodiment of a system for purifying water with ozone.

### DETAILED DESCRIPTION OF SPECIFIC EMBODIMENTS

Various embodiments provide systems that purify water, and yet are small, and inexpensive compared to existing ozone-based water purification systems. Such embodiments may also be less expensive to operate compared to existing ozone-based water purification systems. Some embodiments are also quite compact, and may occupy a volume of less than 2500 cubic inches (for example, less than about 41 liters, or 0.040968 m³), for example. These qualities allow water purification systems to provide clean water in place and in applications where larger and/or more expensive systems are not economically or physically feasible.

In addition to eliminating bacteria from the contaminated water, various embodiments may also remove particulate matter from the water, and mitigate undesirable taste, odor and discoloration of the water.

Purified water may meet a variety of human needs such as human consumption (e.g., drinking and cooking), as well for cleaning dishes or laundry, to name but a few examples. As such, although illustrative embodiments may be described below in terms of providing drinking water, that is not a limitation on the applications of the concepts and inventions described herein.

In general, various embodiments may be implemented by a modular concept that allows various stages of a system to be implemented with a choice from among one or more elements. This allows ease of configuration in order to optimize the system for specific end needs. End needs for example might be, but are not limited to, minimum water flow, minimization of excess waste water and/or purified water resulting from the purification process, portability, effectiveness, system cost, operating cost, or the like.

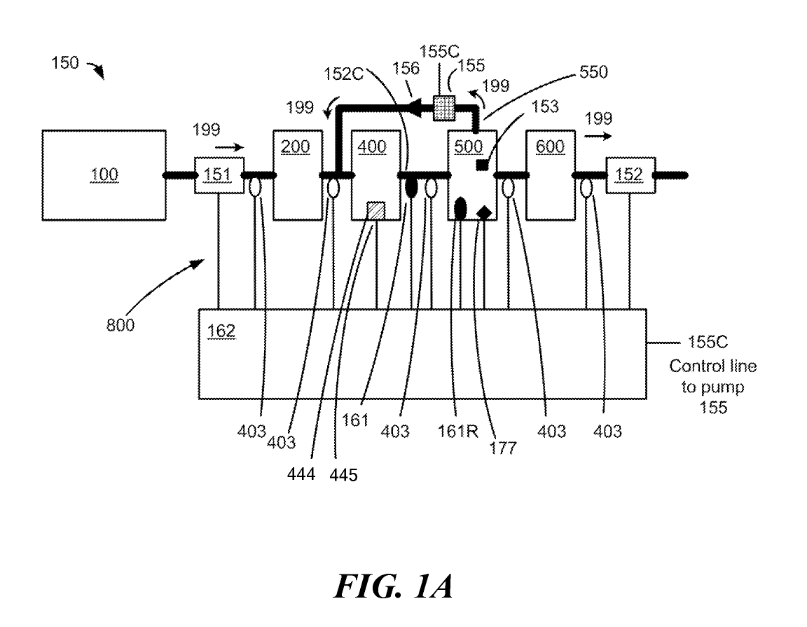

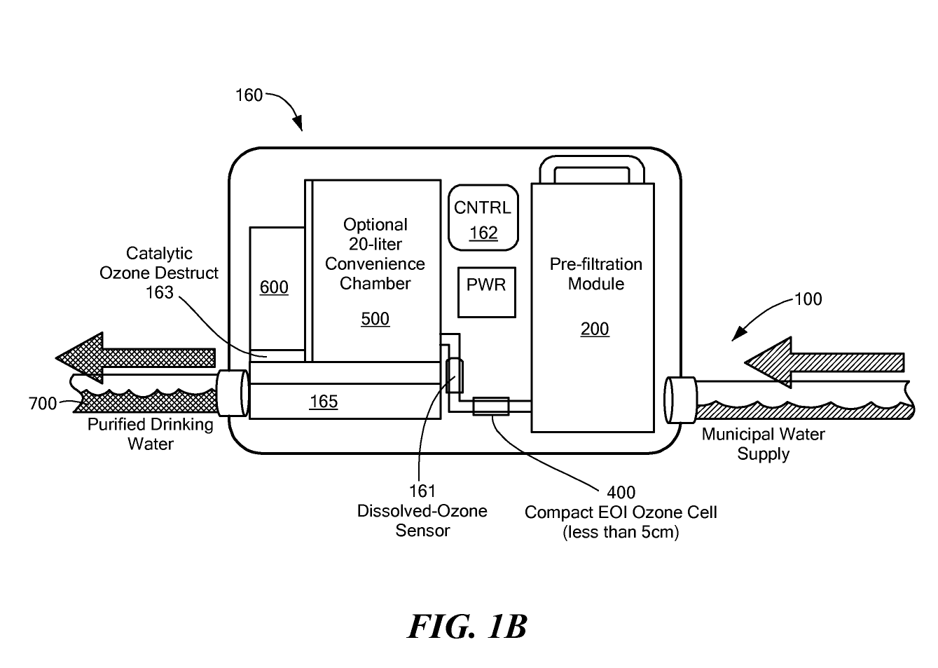

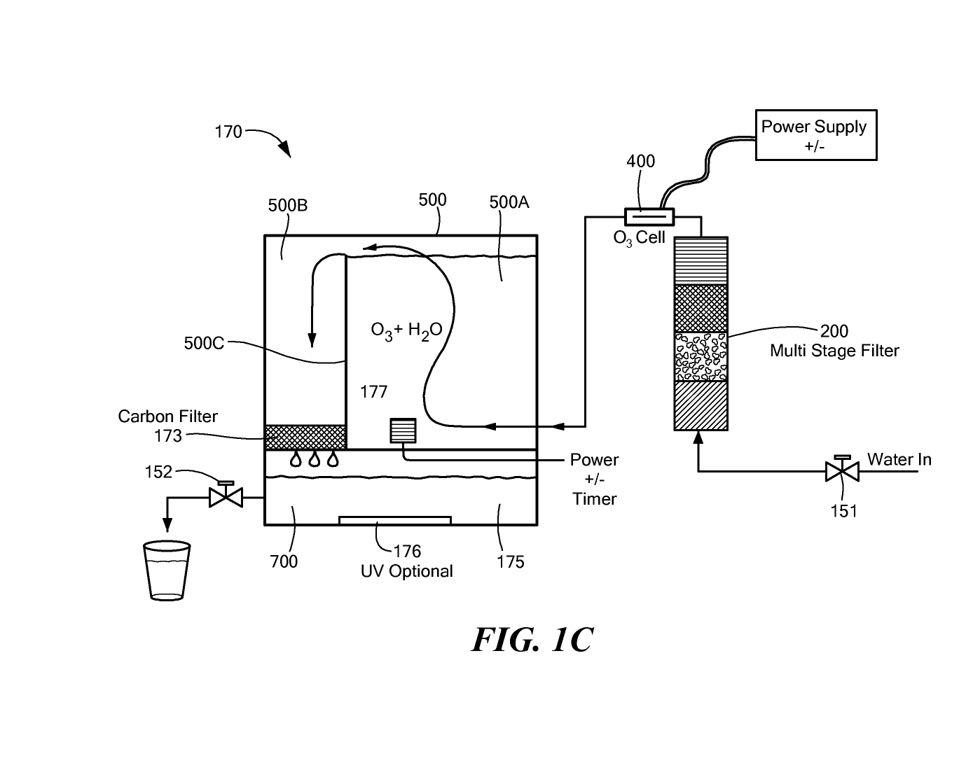

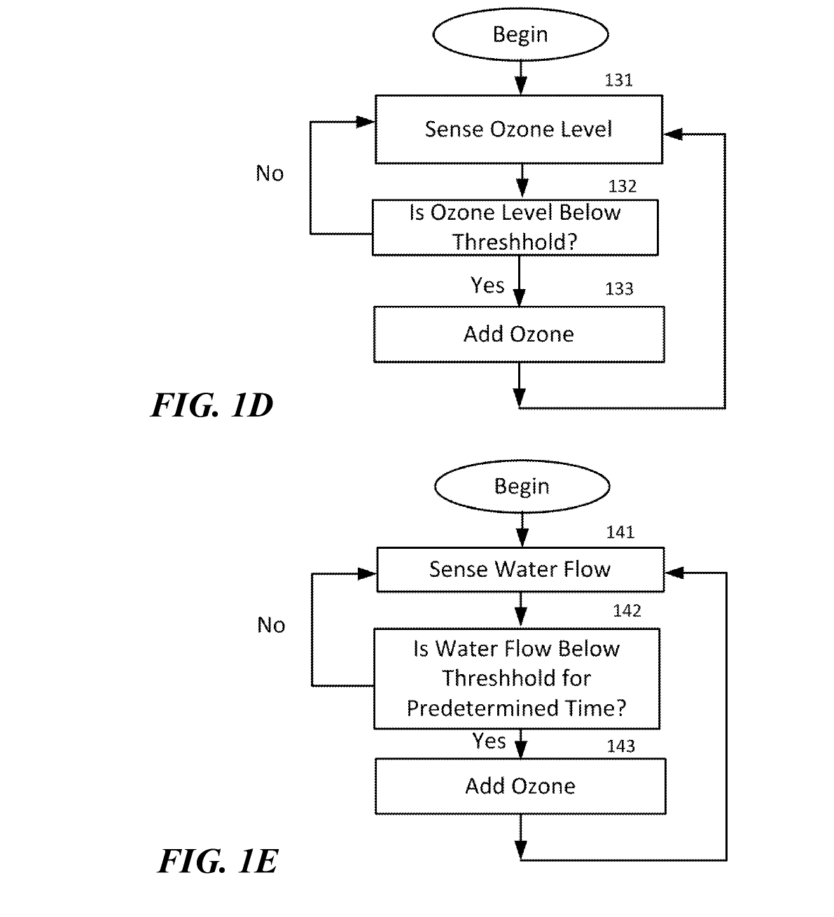

FIG. 1A schematically illustrates a system 150 for purifying water from a source 100 using ozone. The elements of system 150 include a Pre-filter (200), an Ozone source or “ozonator” (400), a Water/Ozone Reservoir (500), and an Ozone Removal element (600). The system 150 processes contaminated water from a source of contaminated water (100) and produces purified drinking water (700) at its outlet (152).

More specifically, unpurified water enters the system 150 through an inlet 151, which may be a controllable valve or other water coupling device to begin its transit through the system 150. Generally, the elements of a water purification system, such as those described herein, are in fluid communication so as to define a water flow path by which water flows through the elements between a system input (e.g., inlet 151) and system output (e.g., outlet 152). In various figures, the direction of water through along a flow path is indicated by small arrows 199. Some embodiments illustrate multiple flow paths (e.g., dual flow paths), which may be parallel flow paths (i.e., in normal operation, water flows through both paths), or which may be alternative flow paths. Generally, an element may be described as being “downstream” from a preceding element then the element receives water that has passed through a preceding element.

Pre-Filter

In operation, incoming water from source 100 is first passed through a pre-filter 200. The pre-filter 200 eliminates various contaminants, and may be a carbon filter, or may be multiple stacked types of physical filters that remove a variety of particulate matter. Alternately, pre-filter 200 may be a reverse osmosis means of particulate purification (typical reverse osmosis filtration removes at least 85% percent of most everything, such as particulates, dissolved minerals, molecules etc.; and everything with a molecular weight greater than 100). In general, any effective modular pre-filter system can be used as long as it meets the needs of the system's specifications.

Ozonator

After leaving the filter, the water passes through an ozonator 400, which is a device that produces ozone in the water in a process that may be known as “ozonation.” In some embodiments, the ozonator 400 may be configured to controllably vary its ozone production. In other words, the ozonator may be a variable-output ozonation cell. To that end, in various embodiments, the ozonator 400 may include a control input 445 in communication with a controller 162. An ozonator may include an ozonator power circuit 444 to provide power to an electrolytic cell, for example. For example, an ozonator power circuit may provide a controlled current to an electrolytic cell. In alternate embodiment, an ozonator power circuit may provide a controlled voltage to an electrolytic cell. In either case, the ozonator power circuit may be controlled, and therefore power to the ozone generator (e.g., and electrolytic cell) may be controlled, by a controller, such as controller 162 described below. To that end, the ozonator may be electrically coupled to a controller 162, as schematically illustrated in FIG. 1A.

In the system 150, ozonation (i.e., providing ozone within the water being purified) is performed by generating ozone from the water and returning it directly into the water. More particularly, ozone may be created electrolytically from the water itself. Unlike ozone produced via coronal discharge, the ozone produced in this way does not produce waste gas, or excess ozone (e.g., ozone that does not end up in the water), and does not carry with it the contaminants found into ozone produced from ambient air via coronal discharge.

A module for electrolytically creating ozone is small, and may be powered by a battery (e.g., a 9-volt battery) or a small solar cell, and lends itself to modularity for the purpose of scaling to system flow rate needs. Such a module may use a doped diamond anode (e.g., a boron doped diamond), for example.

For example, ozone may be produced by one or more diamond electrodes immersed in the water flow stream. Ozone is generated directly on the surface of a diamond electrode when an electric current is passed between the cathode electrode and an anode electrode. The ozone is immediately inserted into the water stream. The resulting ozone concentration in the flow stream can be altered by changing current level, increasing the area of the electrodes or by stacking multiple electrode systems (i.e., configuring multiple electrolytic cells in series, such that water passes serially through the multiple cells).

Some embodiments may include one or more dissolved ozone sensors 161, 161R, as known in the art, which detect the presence of, and/or monitor the content of, ozone in the water. Such a sensor 161 or 161R may act as a safety device to make sure that there is, in fact, ozone in the water, or a desired level of ozone in the water, or even within a feedback system as described in more detail below. In general, one or more ozone sensors may be positioned in the flow path to be in, or between, any of the ozonator (400) and the reservoir (500).

In various embodiments, ozone may be monitored by an ozone sensor 161 either directly or indirectly both in the dissolved or gaseous state.

In the dissolved state electrochemical or light based methods can be highly selective to ozone. For example light based detection at for example UV (254 nm) or visible (580 nm) can be highly selective as ozone absorbs energy in these and other wavelengths. Another known type of inexpensive sensor based on oxidation reduction potential (ORP) is not necessarily selective for ozone (for example it reacts to other oxidative species such as chlorine, hydrogen peroxide etc.) but in any event, water with a high ORP value is by its nature going to be better at killing pathogens than a low ORP. A variety of known and available sensors employing these methods can be configured to show a net increase over an established reference for example, and therefore to provide the necessary sensor function described herein.

Ozone in the gaseous state can be measured by several known electrochemical means, and the dissolved levels may be inferred through outgassing according to Henry's law. A variety of known and available sensors operate on these principles, and therefore would provide the necessary sensor function described herein.

Reservoir

The ozonated water then flows into a contact reservoir 500, where the ozone continues to purify the water.

Purification of the water occurs as the ozone interacts with the contaminants in the water. To achieve an acceptable degree of purification, some processes ensure contact between water and ozone that may be expressed as a function of both the amount of ozone present at the beginning of the contact, and the duration of the contact. Such an expression may be known as “Contact Time” or “Ct.”

For example, some processes may require an Ct (i.e., exposure) of at least 0.9 ppm*minutes, where “ppm” is “parts per million.” As such, ozonated water would require a contact time of 1 minute, with an ozone concentration throughout that minute of at least 0.9 ppm, to achieve an exposure of 0.9 ppm*minutes. Such an ozone concentration may be obtained by providing a greater concentration of ozone at the beginning of the exposure time such that the concentration remains above that target level during the entire exposure time, or establishing such an ozone concentration at the beginning of the exposure time and maintaining at least that concentration in the water via an ozonator to which the water is exposed during the exposure time.

As another example, some processes may require an exposure of 0.48 ppm*minute. In such an embodiment, once the ozone is generated in the water at the rate of 0.48 ppm, ozone of at least that concentration should remain in contact with the water for at least one minute. The combination of ozone combination and contact time is linearly scalable. For example, to achieve a contact of 0.48 ppm*minute, a system could provide 0.24 ppm of ozone for a contact time of two minutes (i.e., Ct=0.24 ppm*2 minutes=0.48 ppm*minute). Similarly, a system could provide 0.96 ppm of ozone for a contact time of half a minute (i.e., Ct=0.96 ppm*0.5 minutes=0.48 ppm*minute).

Contact time takes place in a holding volume, or reservoir 500. Reservoir 500 may have a variety of shapes, such as a cylinder, coiled pipe or any other volumetric vessel.

The reservoir 500 in system 150 is a chamber with a volume of 20 liters. However, that volume is merely illustrative, and other embodiments may have a reservoir with a volume of more than 20 liters or less than 20 liters. In any event, the reservoir holds the ozonated water while the ozone acts to disinfect the water, and also provides convenient storage of purified water for immediate or delayed use.

Some embodiments may agitate the water within the system, for example with the reservoir 500, or in a conduit 152C connecting the ozonator 400 to the reservoir 500, for example. For example, some embodiments include features, such as a propeller 153 or pump, to promote mixing in the reservoir 500 and thereby increase the efficacy and efficiency of the resulting contact time. Use of agitation in the system 150 is generally desirable and increases the effectiveness of the bacteria treating process.

Some embodiments include a secondary ozone cell (or “reservoir cell”) 177 within the reservoir 500. Water introduced into the reservoir 500 via ozone cell 400 already contains ozone sufficient to disinfect the water, but if the water remains in the reservoir for an extended time, it may be desirable to refresh the ozone supply. To that end, secondary ozone cell 177 may be located within the reservoir 500, and may be controlled by the controller (e.g., 162), or simply by a timer.

Recirculation

As ozone dissipates naturally over time there may be occasion where ozonation is required without fresh water entering the tank. One method shown in FIG. 1A involves recirculating water via a recirculation conduit 550 from the reservoir 500 to the ozonator 400 by means of a pump 155 and through a check valve 156. The pump 155 may be controlled by controller 162 via control line 155C, for example. Check valves may be deployed to prevent back flow. Even in conditions in which there is limited or no flow of new water into the storage tank 500 for extended time periods, water recirculated by pump 155 is recirculated through the ozone cell 400 in order to generate additional ozone, or “re-ozonate” the water.

Ozone Removal

If any ozone remains in the water, after the water is treated, it may be necessary or desirable to remove some of the residual ozone—for example, to bring the resulting purified water to acceptable drinkable level. There are several existing technologies for this component which may be employed.

Some embodiments remove excess ozone by passing the water through an ozone removal element 600, such as a carbon post filter, for example. Other embodiments of an ozone removal element 600 remove excess ozone by exposing the water to UV irradiation, and yet other embodiments expose the water to a non-toxic ozone quenching chemical (such as sodium thiosulfate for example) infusion element to remove excess ozone. Some embodiments of an ozone removal element 600 include a nozzle that reduces the water pressure, and remove excess ozone by passing the water through a nozzle, which causes the ozone to outgas from the water, and/or or to produce turbulence to destroy dissolved ozone. Indeed, some embodiments may use several such nozzles in parallel to increase flow-rate. In other embodiments, ozonated water may pass through a pump, and the pumping action acts to remove excess ozone from the water, or pass through or be exposed to another device or stirring element (667) to produce turbulence to destroy dissolved ozone.

Alternately, in some embodiments, excess ozone is removed by passing it through “catalytic ozone destruct” element, such as element 163 in FIG. 1B for example. Ozone has a half-life of approximately 20 minutes in water. To accelerate the deterioration of ozone molecules, the ozonated water may be exposed to a catalyst, such as activated carbon for example. Such a catalyst may be included in a filter (e.g., filter 267 or 173) along with, or in place of, other filter elements.

Alternately, or in addition, ozone may be destroyed by the managed combustion of hydrogen and oxygen gas. As the electrolytic ozone production process can produce small amounts of hydrogen and oxygen these gases can be managed, collected, and released so as to burn within or outside of the vessel. This combustion effectuates removal of the ozone gas as well. Such combustion (which may also be referred-to as explosions) can be managed in a safe manner in order to affect ozone reduction from both gas and water entrapment.

Ultimately, purified water with a safe and acceptable level of ozone may leave the system 150 via an outlet 152. Outlet 152 may be a manually or electronically controlled valve, a faucet, or other coupling member, to name but a few examples.

Feedback

In some embodiments, one or more dissolved ozone sensors 161 may be integrated into a feedback circuit 800 that controls various elements of the system. For example, a controller 162 may receive water flow data from one or more flow sensors 403, and may receive ozone level data from one or more ozone sensors 161. In general, in any of the embodiments described herein, one or more flow sensors 403 may be configured and located to sense and/or measure water flow out of, into, or between the elements of a system, including without limitation an input 151, filter 200, reverse osmosis filter 300, ozonator 400, reservoir 500, ozone removal element 600, and/or output 152.

The controller, running software, may process such data to assess the status of the water within the system (e.g., whether water is flowing, the flow rate of water; the ozone level in water) to assess the operation or state of the system 150. Such a feedback circuit may control water flow, or example by controlling a valve 151, and/or ozone production by the Ozonator 300, to regulate the production of ozonated water. As schematically illustrated in FIG. 1A for example, the controller 162 is electrically coupled to the various flow sensors 403, ozone sensors 161, ozonator 400, and valves 151, 152, so as to receive data from the sensors and provide control inputs to the ozonator 300, and valves 151, 152.

Alternately, or in addition, in various embodiments the feedback circuit 800 may control the system (e.g., 150) in order to maintain the purity of previously ozonated water. For example, a feedback circuit 800 may execute an algorithm, such as the algorithm illustrated by the flow chart in FIG. 1D for example. At step 131, sensor 161 detects the ozone level in the water. That ozone level is compared to a desired threshold (for example, a level directed or set by a user, for example) at step 132. If the level is at or above the threshold, the algorithm loops back to step 131 to re-measure the ozone. Otherwise, the feedback circuit 800 commands the ozonator 400 to increase ozone production, and loops back to step 131 to re-measure the ozone level. In various embodiments, the control circuit 800 may control the ozonator 400 to produce ozone until the measured ozone level reaches the threshold, or may control the ozonator 400 to produce ozone for a fixed, pre-determined amount of time.

Conversely, if the detected ozone level is higher than desired, the feedback circuit 800 may command the ozonator 400 to decrease ozone production.

In some embodiments, the production of ozone may be controlled by the voltage or current driving an electrolytic ozone cell, and such voltage or current may be controlled by a feedback loop circuit including controller 162, for example. In some embodiments, control circuit 162 may be an application specific integrated circuit (ASIC), while in other embodiments the control circuit 162 may be a programmed microprocessor or microcontroller for example. In some embodiments, the controller 162 may be a PIC16F1829, available from Microchip Technology Inc., for example, although other microcontrollers or circuits could also be used. In this embodiment, controller 162 has a programmable CPU, and includes, among other things, digital memory, comparators, an analog-to-digital (A/D) converter, communications interfaces (such as an I2C bus interface or RS232 interface, for example), and various input and output terminals.

The program code for such a programmable controller may reside in a non-transient medium, such as memory or on other media, including static RAM or a CD-ROM to name but a few examples.

Some embodiments include one or more flow rate sensor (or “flow sensors”) 403. Flow sensors 403 may be used, for example, to determine how much time has passed since water flowed through the system, and therefore how much time has passed since freshly ozonated water has been produced. For example, as illustrate in the flow chart in FIG. 1E, the system may sense water flow (if any) at step 141. If not water is flowing, the method may start, or continue, to track the time since the last measured water flow. That elapsed time may be compared to a pre-determined threshold at step 142, and if that elapsed time exceeds the threshold, the feedback system 800 may cause the system to produce freshly ozonated water, or to re-circulate previously ozonated water from reservoir 500, so as to refresh the purified water 700 (step 143).

An alternate embodiment of a water purification system 160 is schematically illustrated in FIG. 1B, and contains many of the elements described above in connection with FIG. 1A. In system 160, the ozonator is a compact ozone cell, for example of the type described in U.S. patent application Ser. No. 13/310,406, filed Dec. 2, 2011 [practitioner's file 3503/109; published as US 2012/0138478 A1], the content of which is incorporated herein by reference, in its entirety. The ozone cell 400 in this embodiment creates ozone by electrolysis using a diamond electrode.

The system 160 also includes a dissolved ozone senor 161, which detects and monitors the ozone content of the water exiting from the ozone cell.

Prior to use, purified water from reservoir 500 passes through ozone removal stage 600. In system 160, excess ozone is removed by passing it through an ozone remover 600, such as a “catalytic ozone destruct” element 163. The purified water 700 is then captured (e.g., for later use) in storage volume 165.

Yet another embodiment of a water purifier system 170 is schematically illustrated in FIG. 1C, and includes a multi-stage pre-filter 171 at the input. In this embodiment, excess ozone is removed by passing it through “carbon filter” 173. After passing though the filter 173, the purified water 700 is held in storage volume 175 (e.g., reservoir 500).

In this embodiment 170, the reservoir may be described as a “spill-over” reservoir, having two chambers 500A and 500B. Ozonated water enters the chamber 500 into contact chamber 500A, where the water undergoes exposure (e.g., Ct) to ozone. Purified water then spills over wall 500C into de-ozonation chamber 500B, before is passes into an ozone removal element 600 (e.g., carbon filter 173).

System 170 also includes an option UV 176 source coupled to storage volume 175. The UV source 176 acts to maintain the purity of the water 700 during storage. The embodiment also includes a secondary ozone cell (or “reservoir ozone cell”) 177 within the reservoir 500.

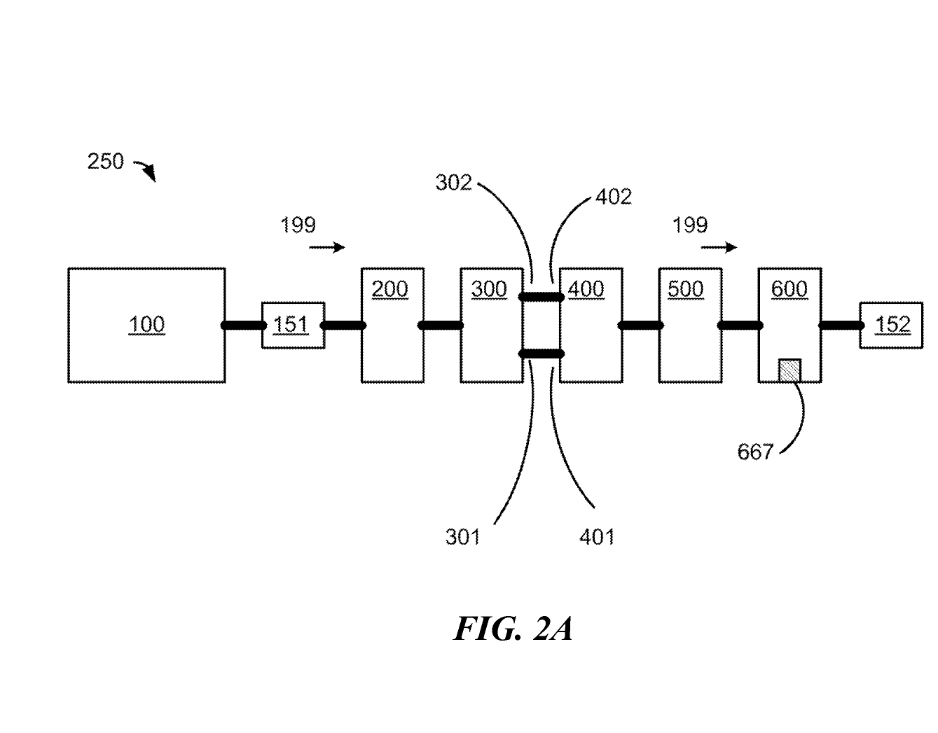

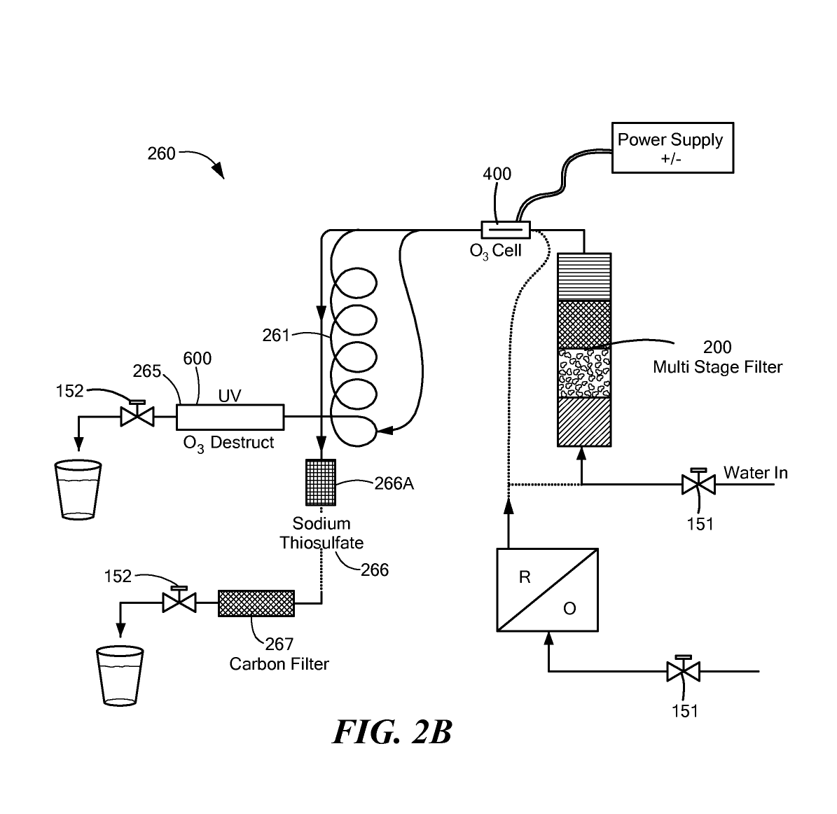

Some embodiments divide the incoming water into two separate paths or streams prior to ozonation by an ozonator that includes electrodes (i.e., anode and cathode) separated by a membrane, such as the system 250 in FIG. 2A, for example. Such embodiments address the particularly nettlesome problem that calcium and magnesium cations can travel across the membrane and combine on the cathode side with carbonate ions to precipitate insoluble scaling products such as calcium or magnesium carbonates. Of important note is that owing to the nature of the operation of the cell, water in the region of the anode becomes locally more acidic (lower pH) and water in the region of the cathode becomes locally more basic (higher pH). This exacerbates the scaling phenomena for calcium and magnesium carbonates because they exhibit a decrease in solubility with an increase in pH. These precipitates then can cover the cathode and impede further electrochemical action thereby rendering the entire cell inoperable.

One approach to addressing this problem is to remove the calcium and magnesium from the water through some sort of filtration. In particular it may be very advantageous to dedicate or direct water that is ‘treated’ to a particular side of the ozone cell whether that is the anode or cathode side depending upon the details of the treatment technology.

Such an embodiment may be advantageous because only one electrode (e.g., the anode) needs be a boron doped diamond, while the hydrogen evolved at the cathode can be occur on any number of inexpensive electrode (cathode) materials such as titanium, stainless steel etc. However, the divided flow approach can be directed at the anode, the cathode or both as shown in examples below.

### EXAMPLE 1

A reverse osmosis (“RO”) filter will remove a substantial percentage of many minerals and chemicals from water. Indeed, it also removes the majority of calcium and magnesium. The RO system is unique in that the output is one high purity stream for final use and one extremely low purity stream (often referred to as brine) which is typically discarded. This presents a unique opportunity for the ozone cell because the high purity water may be exclusively pushed through a dedicated anode chamber and ozonated while at the same time the brine may be used to evolve hydrogen at the cathode and carry that away to drain. This has the advantage of low cost, and also it makes the cell more efficient at delivering ozone because there is no recombination of the ozone and hydrogen (e.g., as might occur if the ozonated water flowing past the anode is allowed to re-combine with the water passing past the cathode).

### EXAMPLE 2

A cation exchange system has a limited lifetime of resin beads (they can only treat so much water before they need to be recharged or discarded). In some embodiments, only water destined for the anode side of a catalytic ozone cell is passed through the cation exchange bed, with the result that the lifetime of the bed is extended, with respect to a system that passes all the water through the bed, by virtue of not treating the catholyte water. The same approach may be employed in various embodiments to any technology that removes calcium and magnesium from the water—i.e., if only the anolyte is treated then the treatment system can be made smaller, cheaper etc. In other words, a substantial reduction of filtering on the catholyte side will be beneficial and in some cases a complete lack of filtration will work. Unlike the reverse osmosis (“RO”) filter described above (Example 1), in some embodiments the anolyte and catholyte may be recombined after the ozone cell.

As another example (Example 3) some embodiments add a scale inhibiting chemical, such as polyphosphate, to the incoming water. However, adding such a chemical costs money and adds chemicals. However, if the anolyte and catholyte streams are divided then the amount of treatment chemicals needed may be reduced. Alternately, or in addition, some embodiments provide a higher concentration of polyphosphate into the catholyte side than anolyte side because the way the polyphosphate works is to inhibit scale growth which occurs at the cathode.

In various embodiments, plumbing dedicated sides of ‘treated’ water through dedicated sides of the electrochemical cells gives the system designer and use more control over byproducts produced by electrochemical reactions of species other than pure water at the electrodes.

One embodiment of an ozone-based water purification system 250 is schematically illustrated in FIG. 2A, and includes a source of contaminated water (100), a Pre-filter (200), an Ozone source (400), a Water/Ozone Reservoir (500), and an Ozone Removal element (600). The system processes the contaminated water and produces purified water at its output (700).

The system 250 also includes a reverse-osmosis filter (300), which filters some or all of the contaminated water prior to ozonation. In this embodiment, the reverse osmosis filter has two outputs, one output 301 provides reverse-osmosis-filtered water (i.e., water that has been filtered by the reverse osmosis filter, which may be referred to as “R.O. filtered water”) to the anode side 401 of ozone source (400) while the other output 302 provides waste water (the remainder of the water from the reverse osmosis filter) to the cathode side 402 of the ozone source (400). In other words, in some embodiments, the variable-output ozonation cell includes a membrane fluidly separating or isolating the anode and the cathode, and the reverse osmosis filter has a first output (301) and a second output (302), the first output (301) providing R.O. filtered water to an anode side of the variable-output ozonation cell where it is electrolyzed to become ozonated water, and the second output (302) provides non-R.O. filtered (or “waste”) water to the cathode side of the variable-output ozonation cell, such that the anode and cathode are fluidly isolated (i.e., the non-R.O. filtered water remains separate from the R.O. filtered water within the variable-output ozonation cell). In this way, the system avoids providing to the diamond anode contaminants in the water (e.g., calcium; magnesium) that might pass through a membrane and produce or facilitate scale at the cathode, and the waste water carries away undesirable hydrogen from the cathode side of the ozonation cell.

An alternate embodiment 260 is schematically illustrated in FIG. 2B. This embodiment includes a coil tube 261 rather than a tank reservoir 500. A coil 261 may agitate the water as the water passes through, thereby facilitating decontamination by mixing the ozone in the water. Other embodiments may include a reservoir 500 or coil 261 with agitation means to further agitate the water. Use of such a coil tube 261 is not limited to dual-path embodiments such as system 260, and indeed maybe used in any of the embodiments described herein.

System 260 schematically illustrates alternative approaches for removing excess ozone from the water. In one alternative, the water is passed exposed to UV radiation in ozone removal chamber 265. In another alternative, a non-toxic ozone quenching chemical 266 such as sodium thio sulfate for example, is added to the water by an injector 266A, and the water is passed through a carbon filter 267.

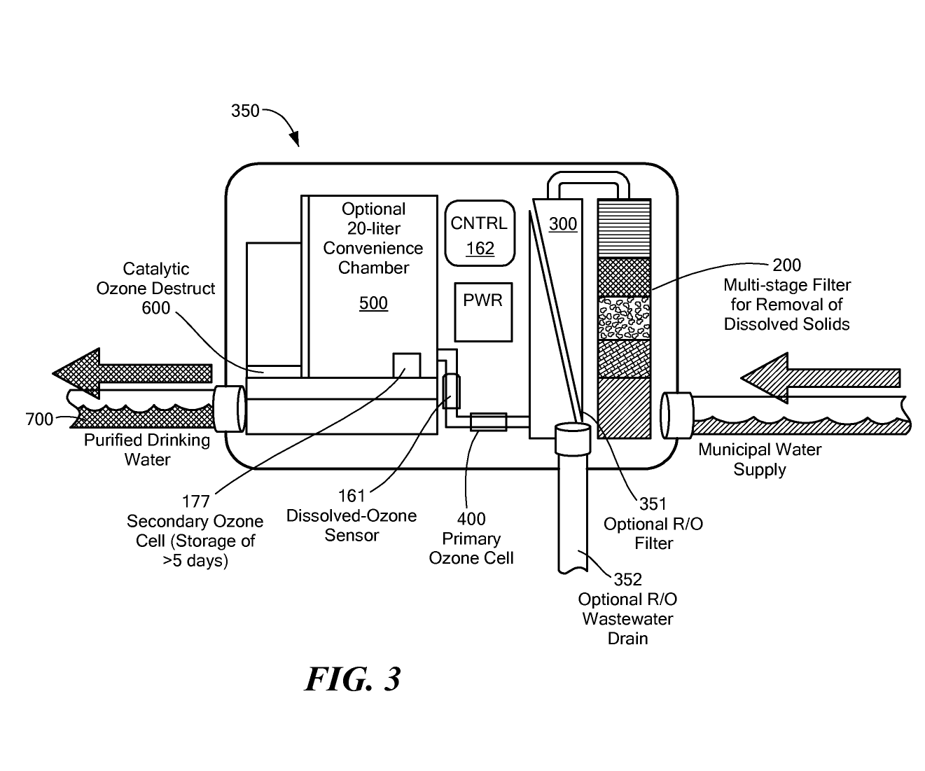

Another embodiment is a water purification system 350 is schematically illustrated in FIG. 3, and contains many of the elements described above. System 350 also includes an option reverse osmosis filter 351 in addition to the pre-filter 200. Specifically, the osmosis filter 351 is in series with pre-filter 200, which is to say that the water passes through both the pre-filter 200 and then through the reverse osmosis filter 351. The reverse osmosis filter 351 produces two streams of water output, one of which proceeds to the ozonator 400, and the other of which is waste water. The waste water carries away the materials filtered-out by the reverse osmosis filter, and is expelled via waste water drain 352.

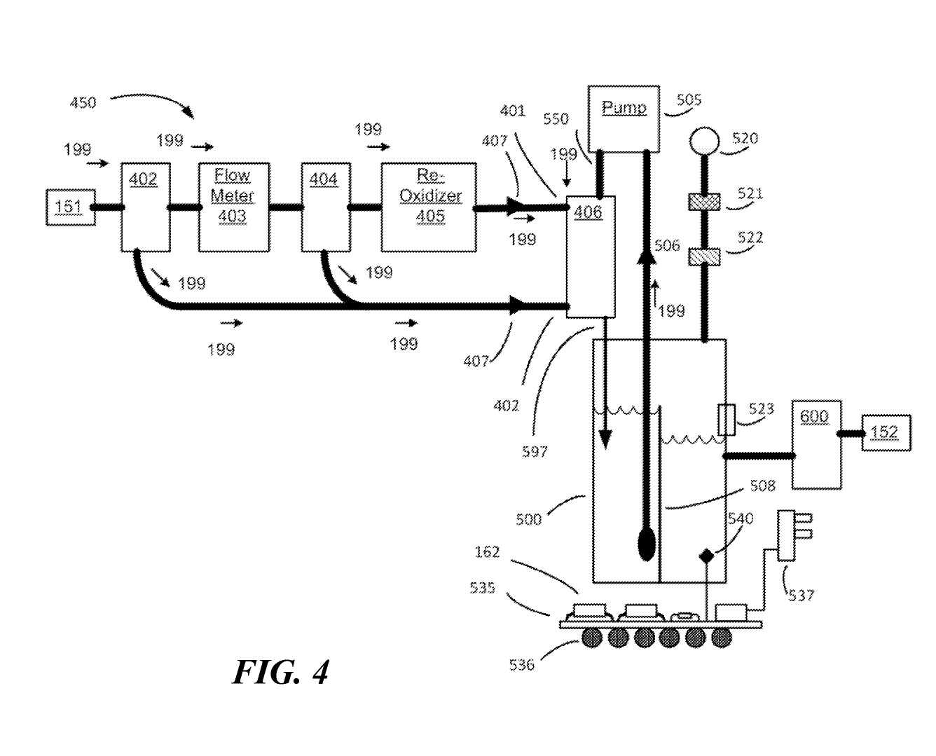

Another embodiment is a water purification system 450 is schematically illustrated in FIG. 4. In this embodiment, water flow is shown from left to right. Item 401 represents the inlet of contaminated water. It flows to pre-filter 402 which may be a multistage (i.e., “stacked”) device including several filter stages, as described above. The pre-filter 402 includes large, medium, and fine particulate removal. It may also contain other pretreatment elements typical of water pre-filters. As schematically illustrated by the various flow paths in FIG. 4 (as designated by arrows 199) the divided flow concept can initiate at this point or later in the circuit.

Optionally a flow meter (403) can be located anywhere in the flow path to provide water flow rate information and cumulative water flow information to the controller, or smart board 535 that includes a controller, e.g., 162). A smart board 535 may process flow information to determine ozone output requested of ozone cell and may take accumulated flow into consideration in controlling the system.

Optionally a reverse osmosis (“R.O.”) filter 404 may be present in the water treatment circuit. In some embodiments, an R.O. filter 404 also servers to divide the water flow into two (i.e., “dual”) paths, such that one path directs water that has passed through a reverse osmosis membrane may be directed to the anode side of an ozonator, and such that the other path directs the remaining water (i.e., which has not passed through the same reverse osmosis membrane) to the cathode side of an ozonator. A membrane within the ozonator may prevent the dual flows of water from recombining within the ozonator.

Either before or after the R.O. filter 404, a pre-oxidizer 405 may be present in the circuit. This pre-oxidizer unit 405 may consist of advanced electronic oxidation technology such as membrane-less boron doped diamond electrodes being operated in such a fashion as to oxidize ions contained in the incoming water flow. Flow maybe divided so that alternate treat pretreatment of water destined for the anolyte chamber versus the catholyte chamber of the ozone cell. Check valves 407 may be used to control the flow.

The concept of contact time is well known within previous ozonation work and efficacy as regards to killing germs and bacteria (exposure time vs concentration required to kill organisms). The ozone cell ozonates water prior to the water entering the storage tank 500. An ozone sensor, such as ORP (ozone reduction potential sensor) or other device or method, 507, is located to sense ozone concentration within the tank 500. Power (e.g., voltage or current) drive level to the ozonator 406 can be adjusted, for example by a feedback circuit 800, as may be required due to flow rate to achieve a desired, controllable concentration of ozone.

As ozone dissipates naturally over time there may be occasion where ozonation is required without fresh water entering the tank. One method shown in FIG. 3 involves recirculating water by means of a pump 505 through a check valve 506. Check valves are deployed as required in order to prevent back. Even in conditions in which there is limited or no flow of new water into the storage tank 500 for extended time periods, water recirculated via recirculation conduit 550 by pump 505 is returned to and passed through the ozone cell 406 in order to generate additional ozone in the water. In both cases of recirculated flow and of normal incoming flow, ozone is produced in the left side of the reservoir 500 so that adequate contact time is achieved. As ozonated water flows over the baffle 508 in the tank 500 it is available to flow to outlet (e.g., 152). The recirculation line 597 from the pump 505 flows thru check valve 506 and back to the tank (reservoir) 500.

An alternate method for periodically ozonating water in tank is the ozone cell 540 which operates periodically without pump mechanism while deployed in tank 500. Care must be taken not to overheat the cell structure and as a result current drive level must be kept low or cell size small to avoid overheating and resulting damage to membrane. Multiple periodic ozonators 540 can be used as required to maintain a target ozone concentration.

As an additional or alternate means of sustained ozonation there may be an ozone bubbler (also represented by item 540) located in the bottom of the tank. This is a small ozone cell that produces ozone which directly is admitted to the tank. The source of energy for this bubbler and maybe a constant current drive circuit as has been elsewhere described. The constant current circuit may be powered by a controller 162 (e.g., as part of SmartBoard 535). The power source for the circuitry and/or an entire system may be an AC or DC power source 157. In some embodiments, the power source may be backed-up by a rechargeable battery or traditional batteries (536); in either case accomplishing power back up in the event of a power outage.

Some embodiments include a vent 520 configured and located to purge gas or air from the storage tank 500. In some embodiments, both ozone and moisture may be voided from the vent 520. Filter 521 is a filter, such as a manganese oxide air filter for example, which removes ozone from the escaping gas. Additionally, some embodiments include a hydrophobic membrane 522 to ensure that moisture does not contaminate manganese oxide in filter 521. A method of/device 523 for water level detection maybe employed in the tank 500, and may be a magnetic float for example, in order to ensure that the fluid level does not rise to the point where it would cause water to enter the gas vent one 520.

In order to prevent contamination during power outage, some embodiments include rechargeable battery pack 536 is employed. Batteries 536 may be recharged by a wall mount transformer 537, or ultimately may be replaced periodically or as needed. In any event the periodic ozonator 540 is a low capacity sustained ozone production device deployed directly and large tank without force connection means. The ozone simply bubbles through the tank circulated in part by the gas bubbles

Item 600 shown here in the output water line represents a means of ozone destruction within the liquid water. There are several existing technologies for this component which may be employed, as described above.

Decontaminated water 700 can then be brought forward and output (e.g., via a valve 152) to a user.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. For example, as noted above, some systems are modular, and may be constructed by combining any of the variations of the elements described here to provide a flow path. All such variations and modifications are intended to be within the scope of the present invention as defined in any appended claims.

What is claimed is:

1. A system for purifying water with ozone, comprising:
a water inlet for receiving unpurified water;
a pre-filter in fluid communication with the water inlet;
a variable-output ozonation cell comprising a control input, a cathode, and a doped diamond anode, and configured to create ozone from the water, the ozonation cell in fluid communication with the pre-filter;
a water reservoir configured to store ozonated water, the water reservoir in fluid communication with the ozonation cell;
an ozone removal chamber configured to receive ozonated water from the water reservoir, and configured remove ozone from the water;
a system outlet in fluid communication with the ozone removal chamber, and configured to output purified water, the water inlet, pre-filter, ozonation cell, water reservoir, ozone removal chamber, and system outlet defining a fluid path through the system;
a feedback circuit comprising:
an ozonation sensor coupled to the fluid path downstream from the ozonation cell, the ozonation sensor coupled to detect the level of ozone in the ozonated water;
a controller configured to receive ozone data from the ozone sensor, and configured to control the ozone production of the ozonation cell.

2. The system for purifying water of claim 1, wherein the water reservoir further comprises:
a reservoir ozonation cell in fluid contact with the ozonated water and in electrical communication with the controller, and
a reservoir ozonation sensor configured to detect ozone levels in ozonated water within the reservoir, the reservoir ozonation sensor in electrical communication with the controller;
wherein the controller is configured to cause the reservoir ozonation cell to produce ozone from water within the reservoir when the reservoir ozonation sensor detects ozone levels within the ozonated water less than a pre-determined threshold.

3. The system for purifying water of claim 1, wherein:
the water reservoir further comprises a reservoir ozonation sensor configured to detect ozone levels in ozonated water within the reservoir, the reservoir ozonation sensor in electrical communication with the controller; and
the system further comprises a recirculation conduit configured to pass water from the water reservoir back to the ozonation cell;
wherein the controller is configured to recirculate water from the water reservoir to the ozonation cell via the recirculation conduit, and to cause the ozonation cell to re-ozonate said water, when the reservoir ozonation sensor detects ozone levels within the ozonated water less than a pre-determined threshold.

4. The system for purifying water of claim 1, further comprising:
a water flow sensor coupled to the fluid path and configured to determine whether water is flowing along at least a portion of the fluid path; and
a reservoir ozonation cell in fluid contact with the ozonated water within the reservoir;
wherein the controller is configured to assess data from the water flow sensor and to cause the reservoir ozonation cell to produce ozone from water within the reservoir if no water has flowed past the water flow sensor during a pre-determined interval.

5. The system for purifying water of claim 1, further comprising:
a water flow sensor coupled to the fluid path and configured to determine whether water is flowing along at least a portion of the fluid path; and
a recirculation conduit configured to pass water from the water reservoir back to the ozonation cell;
wherein the controller is configured to assess data from the water flow sensor and to recirculate water from the water reservoir to the ozonation cell via the recirculation conduit, and to cause the ozonation cell to re-ozonate said water, if no water has flowed past the water flow sensor during a pre-determined interval.

6. The system for purifying water of claim 1, wherein the pre-filter comprises a carbon filter.

7. The system for purifying water of claim 1, wherein the pre-filter comprises a stacked-type physical filter.

8. The system for purifying water of claim 1, further comprising a reverse osmosis filter in the fluid path between the pre-filter and the ozonation cell.

9. The system for purifying water of claim 8, wherein
the variable-output ozonation cell further comprise a cell membrane fluidly isolating the anode from the cathode, and
the reverse osmosis filter has a first output and a second output fluidly isolated from the first output, the first output providing R.O. filtered water to an anode side of the variable-output ozonation cell, and the second output provides waste water to the cathode side of the variable-output ozonation cell, such that the waste water remains separate from ozonated water within the variable-output ozonation cell.

11. The system for purifying water of claim 1, wherein the ozone removal chamber comprises a pressure-reducing nozzle configured to reduce the pressure in flowing water so as to cause ozone to outgas from the water and/or or to produce turbulence to destroy dissolved ozone.

12. The system for purifying water of claim 1, wherein the ozone removal chamber comprises a pump.

13. The system for purifying water of claim 1, wherein the ozone removal chamber comprises a non-toxic ozone quenching chemical infusion element.

14. A method of operating a water purification system, comprising:
passing water through at least one pre-filter;
passing the water through an ozonator downstream from the pre-filter;
capturing the water in a reservoir downstream from the ozonator;
determining whether to re-ozonate the water in the reservoir; and
re-ozonating the water in the reservoir.

15. The method of operating a water purification system according to claim 14, wherein monitoring the ozone level of the water in the reservoir comprises sensing the ozone level via an ozone sensor.

16. The method of operating a water purification system according to claim 14, wherein monitoring the ozone level of the water in the reservoir comprises monitoring water flow through the water purification system and determining whether the water flow is below a pre-determined threshold.

17. The method of operating a water purification system according to claim 16, wherein determining whether the water flow is below a pre-determined threshold comprises determining whether the water flow has been below the pre-determined threshold for a predetermined period of time.

18. The method of operating a water purification system according to claim 14, wherein re-ozonating the water in the reservoir comprises recirculating at least a portion of the water in the reservoir through the ozonator.

19. The method of operating a water purification system according to claim 14, wherein re-ozonating the water in the reservoir comprises providing ozone to the water in the reservoir via a reservoir ozonator within the reservoir.

20. A system for purifying water with ozone, comprising:
a water inlet means for receiving unpurified water;
a pre-filter mean in fluid communication with the water inlet means;
a variable-output ozonation means comprising a control input and a doped diamond electrode, and configured to create ozone from the water, the ozonation means in fluid communication with the pre-filter;
a water reservoir means configured to store ozonated water, the water reservoir in fluid communication with the ozonation cell;
an ozone removal means configured to receive ozonated water from the water reservoir, and configured remove ozone from the water;
a system outlet means in fluid communication with the ozone removal chamber, and configured to output purified water, the water inlet means, pre-filter, ozonation means, water reservoir means, ozone removal means, and system outlet means defining a fluid path through the system;
a feedback means comprising:
an ozonation sensor coupled to the fluid path downstream from the ozonation means, the ozonation sensor coupled to detect the level of ozone in the ozonated water;
a controller means configured to receive ozone data from the ozone sensor, and configured to control the ozone production of the ozonation cell.
